(19) United States
(12) Patent Application Publication
(10) Pub. No.: US 2007/0020494 A1
(43) Pub. Date: Jan. 25, 2007

(54) Solid-oxide fuel-cell power generating apparatus

(76) Inventors: Michio Horiuchi, Nagano-Shi (JP); Shigeaki Suganuma, Nagano-Shi (JP); Yasue Tokutake, Nagano-Shi (JP); Misa Watanabe, Chandler, AZ (US)

Correspondence Address: MORGAN & FINNEGAN, L.L.P., 3 WORLD FINANCIAL CENTER, NEW YORK, NY, 10281-2101, US

(21) Appl. No.: 11/395,113

(22) Filed: Mar. 31, 2006

(30) Foreign Application Priority Data
Jul. 19, 2005 (JP) 2005-208552

(51) Int. Cl. H01M 8/04; H01M 8/12

(52) U.S. Cl. 429/26; 429/30; 429/32

(57) ABSTRACT

The present invention relates to a power generating apparatus that generates electric power, using a solid oxide fuel cell, by directly exposing the fuel cell to a premixed gas combustion flame formed in a gas-fired kichen range. The solid oxide fuel cell is supported by lead wires fixed to a mounting base so that the fuel cell faces a burner located in the center of the gas-fired stove. An anode electrode layer is directly exposed to the flame produced by the burner, and is thus kept in a fuel-rich condition, while a cathode electrode layer is kept in an air-rich condition. An output of the fuel cell is taken out through the lead wires.

### CROSS-REFERENCE TO RELATED APPLICATION

This application claims the priority of Japanese Patent Application Number 2005-208552, filed on Jul. 19, 2005.

### BACKGROUND OF THE INVENTION

1. Field of the Invention

The present invention relates to a solid-oxide fuel-cell power generating apparatus and, more particularly, to a handy and easy-to-handle solid-oxide fuel-cell power generating apparatus comprising a solid oxide fuel cell unit and capable of generating power by directly exposing the fuel cell unit to a premixed gas combustion flame produced by a burner of a gas-fired heater, for example, a gas fired stove, wherein the solid oxide fuel cell unit is fabricated by forming a cathode electrode layer and an anode electrode layer on a solid oxide substrate and by employing a simple structure that does not require hermetic sealing.

2. Description of the Related Art

Fuel cells so far developed can be classified into various types according to the method of power generation, one being the type of fuel cell that uses a solid electrolyte. In one example of the fuel cell that uses a solid electrolyte, a calcined structure made of yttria (Y₂O₃)-doped stabilized zirconia is used as an oxygen ion conducting solid oxide substrate. This fuel cell comprises a cathode electrode layer formed on one surface of the solid oxide substrate and an anode electrode layer on the opposite surface thereof, and oxygen or an oxygen-containing gas is supplied to the cathode electrode layer, while a fuel gas such as methane is supplied to the anode electrode layer.

In this fuel cell, the oxygen (O₂) supplied to the cathode electrode layer is converted into oxygen ions (O²⁻) at the boundary between the cathode electrode layer and the solid oxide substrate, and the oxygen ions are conducted through the solid oxide substrate into the anode electrode layer where the ions react with the fuel gas, for example, a methane gas (CH₄), supplied to the anode electrode layer, producing water (H₂O), carbon dioxide (CO₂), hydrogen (H₂), and carbon monoxide (CO). In this reaction process, the oxygen ions release electrons, and a potential difference therefore occurs between the cathode electrode layer and the anode electrode layer. Here, when lead wires are attached to the cathode electrode layer and the anode electrode layer, the electrons in the anode electrode layer flow into the cathode electrode layer via the lead wires, and the fuel cell thus generates electric power. The operating temperature of this fuel cell is about 1000° C.

However, this type of fuel cell requires the provision of separate chambers, one being an oxygen or oxygen-containing gas supply chamber on the cathode electrode layer side and the other a fuel gas supply chamber on the anode electrode layer side; furthermore, as the fuel cell is exposed to oxidizing and reducing atmospheres at high temperatures, it has been difficult to increase the durability of the fuel cell unit.

On the other hand, there has been developed a fuel cell of the type that comprises a fuel cell unit fabricated by forming a cathode electrode layer and an anode electrode layer on opposite surfaces of a solid oxide substrate, and that generates an electromotive force between the cathode electrode layer and the anode electrode layer by placing the fuel cell unit in a fuel gas mixture consisting of a fuel gas, for example, a methane gas, and an oxygen gas. The principle of generating an electromotive force between the cathode electrode layer and the anode electrode layer is the same for this type of fuel cell as for the above-described separate-chamber type fuel cell but, as the whole fuel cell unit can be exposed to substantially the same atmosphere, the fuel cell can be constructed as a single-chamber type cell to which the fuel gas mixture is supplied, and this serves to increase the durability of the fuel cell unit.

However, in this single-chamber fuel cell also, as the fuel cell has to be operated at a high temperature of about 1000° C., there is the danger that the fuel gas mixture may explode. Here, if the oxygen concentration is reduced to a level lower than the ignitability limit to avoid such a danger, there occurs the problem that carbonization of the fuel, such as methane, progresses and the fuel cell performance degrades. In view of this, there has been developed a single-chamber fuel cell that can use a fuel gas mixture whose oxygen concentration is adjusted so as to be able to prevent the progress of carbonization of the fuel while, at the same time, preventing an explosion of the fuel gas mixture.

The fuel cell so far described is of the type that is constructed by housing the fuel cell unit in a chamber having a hermetically sealed structure; on the other hand, there is proposed an apparatus that generates power by placing a solid oxide fuel cell unit in or near a flame and thereby holding the solid oxide fuel cell unit at its operating temperature.

The fuel cell unit used in the above-proposed power generating apparatus comprises a zirconia solid oxide substrate formed in a tubular structure, a cathode electrode layer as an air electrode formed on the inner circumference of the tubular structure, and an anode electrode layer as a fuel electrode formed on the outer circumference of the tubular structure. This solid oxide fuel cell unit using the solid electrolyte is placed with the anode electrode layer exposed to a reducing flame portion of a flame generated from a combustion device to which the fuel gas is supplied. In this arrangement, radicals, etc. present in the reducing flame can be utilized as the fuel, while air is supplied by convection or diffusion to the cathode electrode layer inside the tubular structure, and the solid oxide fuel cell unit thus generates electric power.

The earlier described single-chamber fuel-cell obviates the necessity of strictly separating the fuel and the air as was the case with conventional solid oxide fuel cells but, instead, has to employ a hermetically sealed construction. Further, to increase the electromotive force, a plurality of flat plate solid oxide fuel cell units are stacked one on top of another and connected together using an interconnect material having high heat resistance and high electrical conductivity so as to be able to operate at high temperatures. As a result, the single-chamber fuel-cell device constructed from a stack of flat plate solid oxide fuel cell units has the problem that the construction is not only large but also costly.

Furthermore, in operation, the temperature is gradually raised to the high operating temperature in order to prevent cracking of the solid electrolyte fuel cell units; therefore, the single-chamber fuel-cell device requires a significant startup time, thus causing extra trouble to operate.

By contrast, the above-proposed solid oxide fuel cell unit of tubular structure employs a construction that directly utilizes a flame; this type of fuel cell has the characteristic of being an open type, the solid electrolyte fuel cell unit not needing to be housed in a hermetically sealed container. As a result, this type of fuel cell can reduce the startup time, is simple in structure, and is therefore advantageous when it comes to reducing the size, weight, and cost of the fuel cell. Further, as the flame is directly used, this type of fuel cell can be incorporated in a conventional combustion apparatus or an incinerator or the like, and is thus expected to be used as a power supply apparatus.

However, in this type of fuel cell, as the anode electrode layer is formed on the outer circumference of the tubular solid oxide substrate, radicals due to the flame are not supplied, in particular, to the lower half of the anode electrode layer, and effective use cannot be made of the entire surface of the anode electrode layer formed on the outer circumference of the tubular solid oxide substrate. This has degraded the power generation efficiency. There has also been the problem that, as the solid oxide fuel cell unit is directly and unevenly heated by the flame, cracking tends to occur due to rapid changes in temperature.

In view of the above situation, Japanese Unexamined Patent Publication No. 2004-139936, for example, proposes a power generating apparatus using a solid oxide fuel cell as a handy power supply means, wherein improvements in durability and power generation efficiency and reductions in size and cost are achieved by employing a solid oxide fuel cell of the type that directly utilizes a flame produced by burning a fuel, and by making provisions to apply the flame over the entire surface of the anode electrode layer formed on a flat plate solid oxide substrate.

As described above, the previously proposed solid-oxide fuel-cell power generating apparatus requires, in the case of the chamber type, the provision of an electric oven for heating the solid oxide fuel cell unit to its operating temperature and a supply device for supplying a fuel gas and oxygen or air; as a result, the apparatus itself is complex and large in construction, and the apparatus as a power generating apparatus has not been the type that a person can carry around.

On the other hand, the previously proposed power generating apparatus using the solid oxide fuel cell unit that directly utilizes a flame requires the provision of a combustion device for producing a flame by burning a fuel, but has the advantage that a small, compact, and light-weight power generating apparatus can be achieved because a candle, a lighter, or another handy device, that can produce a flame, can be used as the combustion device. However, while power can be generated in a simple manner, this type of power generating apparatus has had problems such as safety concerns involved because it directly uses a flame and an inability to obtain a stable flame because the flame used is a diffusion flame; for these and other reasons, it has been difficult to use this apparatus for stable power generation.

It is accordingly an object of the present invention to provide a solid-oxide fuel-cell power generating apparatus that generates power using a solid oxide fuel cell unit by directly exposing the fuel cell unit to a flame and that is small, light-weight, safe, and easy to handle; to achieve this, a premixed gas combustion flame produced by a burner of a gas-fired heater, for example, a gas-fired stove, capable of stably supplying fuel is utilized when generating power using the solid oxide fuel cell unit.

### SUMMARY OF THE INVENTION

To solve the above problems, a solid-oxide fuel-cell power generating apparatus according to the present invention comprises: a solid oxide fuel cell unit having a solid oxide substrate, a cathode electrode layer formed on one surface of the substrate, and an anode electrode layer formed on a surface of the substrate opposite from the one surface; and a fuel cell mounting base which supports the solid oxide fuel cell unit in such a manner that the anode electrode layer is directly exposed to a premixed gas combustion flame produced by a burner of a gas-fired stove, wherein power is generated by supplying components of the premixed gas combustion flame to the anode electrode layer and air to the cathode electrode layer.

A current collecting electrode provided in either one or both of the cathode electrode layer and the anode electrode layer is formed from a metal mesh spreading over an entire surface of the electrode layer, the fuel cell mounting base is provided on a top surface of a body of the gas-fired heater, and the solid oxide fuel cell unit is disposed so as to face the burner.

Further, the fuel cell mounting base is capable of supporting the solid oxide fuel cell unit in such a manner as to be freely tilted at a desirable angle, and the solid oxide fuel cell unit is supported on the fuel cell mounting base by means of a power extracting lead wire attached to the fuel cell unit.

A plurality of such solid oxide fuel cell units are arranged so as to face the burner, and the plurality of solid oxide fuel cell units are connected in series or parallel or in series and parallel, wherein the series or parallel connection or the series and parallel connection of the plurality of solid oxide fuel cell units is accomplished by means of an electrical conductor detachable from lead wires attached to the solid oxide fuel cell units.

An upper end of the solid oxide fuel cell unit does not protrude above an upper surface of a trivet placed on the gas-fired heater, or alternatively, the upper end of the solid oxide fuel cell unit protrudes above the upper surface of the trivet placed on the gas-fired heater.

The solid oxide fuel cell unit comprises a plurality of cathode electrode layers formed on one surface of the solid oxide substrate and a plurality of anode electrode layers formed on a surface of the solid oxide substrate opposite from the one surface, and a plurality of fuel cell units are formed by the anode electrode layers and the cathode electrode layers formed opposite each other across the solid oxide substrate.

Further, in the solid-oxide fuel-cell power generating apparatus of the present invention, the solid oxide fuel cell unit is supported on the fuel cell mounting base in a freely detachable manner.

As described above, the solid-oxide fuel-cell power generating apparatus according to the present invention comprises the solid oxide fuel cell unit, which includes the solid oxide substrate, the cathode electrode layer, and the anode electrode layer, and the fuel cell mounting base, which supports the solid oxide fuel cell unit in such a manner that the anode electrode layer is directly exposed to the premixed gas combustion flame produced by the burner of the gas-fired heater, and electric power is generated by supplying components of the premixed gas combustion flame produced by the burner of the gas-fired stove to the anode electrode layer while supplying air to the cathode electrode layer. As a result, the premixed gas combustion flame produced by the burner of the gas-fired heater is not only formed consistently and stably at the burner ports but also is burned safely, and the solid oxide fuel cell unit can be easily held at its operating temperature by the heat of the premixed gas combustion flame; furthermore, radicals contained in the premixed gas combustion flame can be stably supplied as the fuel for the fuel cell.

Further, the flat plate solid oxide fuel cell unit is mounted on the heater equipped with a gas-fired burner by using the fuel cell mounting base; the power generating apparatus thus constructed is small, light-weight, and compact, and can generate power without compromising the function of the gas-fired stove as a cookstove; furthermore, the power generating apparatus can be used as a handy apparatus for power generation. In an alternatively mode, by increasing the cell area of the solid oxide fuel cell which itself glows when heated, a power generating apparatus is constructed that can stably produce a large power output by using the gas-fired heater as a fuel source, and that can generate power while using the gas-fired heater as a space-heating apparatus.

### BRIEF DESCRIPTION OF THE DRAWINGS

Other features, objects and advantages of the present invention will become apparent from the following description of preferred embodiments with reference to the drawings in which like reference characters designate like or corresponding parts throughout several views, and in which:

FIG. 1 is a diagram for explaining a first embodiment in which a solid-oxide fuel-cell power generating apparatus according to the present invention is incorporated in a gas-fired stove;

FIG. 2 is a diagram for explaining a modified example of the solid-oxide fuel-cell power generating apparatus according to the first embodiment;

FIG. 3 is a diagram for explaining a second embodiment in which a solid-oxide fuel-cell power generating apparatus according to the present invention is incorporated in a gas-fired stove;

FIGS. 4A and 4B are diagrams for explaining a modified example of the solid-oxide fuel-cell power generating apparatus according to the second embodiment; and

FIG. 5 is a diagram for explaining how electric power is generated by a solid oxide fuel cell using a gas-fired flame as a fuel.

### DESCRIPTION OF THE PREFERRED EMBODIMENTS

Embodiments of a solid-oxide fuel-cell power generating apparatus according to the present invention will be described below with reference to the drawings. However, before proceeding to the description of the solid-oxide fuel-cell power generating apparatus of the present embodiments, a previously proposed solid-oxide fuel-cell power generating apparatus will be described in order to clarify the features and advantages of the present embodiments.

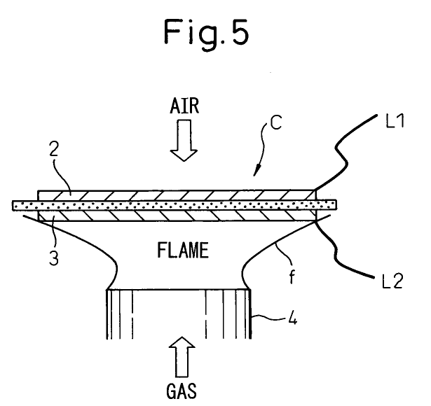

FIG. 5 shows the previously proposed solid-oxide fuel-cell power generating apparatus. The solid oxide fuel cell unit C used in the power generating apparatus shown in FIG. 5 comprises a flat plate solid oxide substrate 1 circular or rectangular in shape, a cathode electrode layer 2 as an air electrode formed on one surface of the substrate, and an anode electrode layer 3 as a fuel electrode formed on the opposite surface thereof. The cathode electrode layer 2 and the anode electrode layer 3 are disposed in such a manner as to face each other with the solid oxide substrate 1 interposed therebetween.

The power generating apparatus is constructed using the thus constructed solid oxide fuel cell unit C; more specifically, the fuel cell unit C with the anode electrode layer 3 facing down is placed above a combustion device 4 to which a fuel gas is supplied, and power is generated by directly exposing the anode electrode layer 3 to a flame f formed by the combustion of the fuel. A fuel that burns and oxidizes by forming a flame is supplied as the fuel to the combustion device 4. As the fuel, phosphorus, sulfur, fluorine, chlorine, or their compounds may be used, but an organic substance that does not need exhaust gas treatment is preferable. Such organic fuels include, for example, gases such as methane, ethane, propane, and butane, gasoline-based liquids such as hexane, heptane, octane, alcohols such as methanol, ethanol, and propanol, ketons such as acetone, and various other organic solvents, edible oil, kerosene, paper, wood, etc. Of these fuels, a gaseous fuel is particularly preferable.

Further, the flame may be a diffusion flame or a premixed gas combustion flame, but the premixed gas combustion flame is preferred because a diffusion flame is unstable and tends to incur degradation of the performance of the anode electrode layer due to the production of soot. The premixed gas combustion flame is not only stable but the flame size is easily adjustable; in addition, the production of soot can be prevented by adjusting the fuel density.

As the solid oxide fuel cell unit is formed in a flat plate shape, the flame f produced by the combustion device 4 can be applied uniformly over the anode electrode layer 3 of the solid oxide fuel cell unit C; that is, compared with the tubular type, the flame f can be applied evenly. Furthermore, with the anode electrode layer 3 disposed facing the flame f, hydrocarbons, hydrogen, radicals (OH, CH, C2, O₂H, CH₃), etc. present in the flame can be easily utilized as the fuel to generate power based on the oxidation-reduction reaction. Further, the cathode electrode layer 2 is exposed to an oxygen-containing gas, for example, air, making it easier to utilize the oxygen from the cathode electrode layer 2; here, if provisions are made to blow the oxygen-containing gas toward the cathode electrode layer 2, the cathode electrode layer can be maintained in an oxygen-rich condition more efficiently.

The power generated by the solid oxide fuel cell unit C is taken between the lead wires L1 and L2 brought out from the cathode electrode layer 2 and the anode electrode layer 3, respectively. For the lead wires L1 and L2, platinum or a platinum-containing alloy is used.

In view of the above, in the present invention, a premixed gas combustion flame produced by a burner of a gas-fired heater, for example, a gas-fired stove capable of stably supplying fuel is utilized when generating power using the solid oxide fuel cell unit, thereby achieving power generation using the solid oxide fuel cell which is directly exposed to the flame.

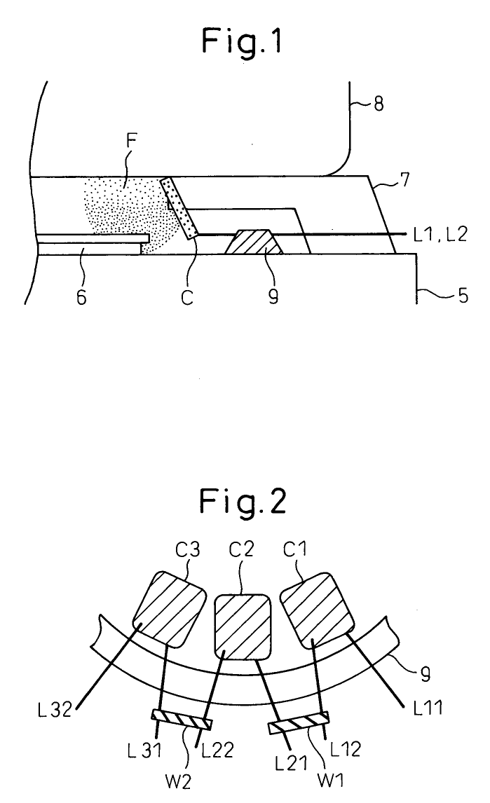

Next, the embodiments of the solid-oxide fuel-cell power generating apparatus according to the present invention will be described with reference to FIGS. 1 to 4. First, the solid oxide fuel cell unit that can be used in the power generating apparatus of the present embodiments will be described below.

The structure of the solid oxide fuel cell unit used in the present embodiments is basically the same as that of the solid oxide fuel cell unit C shown in FIG. 5, and comprises a solid oxide substrate 1, a cathode electrode layer 2, and an anode electrode layer 3.

The solid oxide substrate 1 is, for example, a flat rectangular plate, and the cathode electrode layer 2 and the anode electrode layer 3 are respectively formed over almost the entire surfaces of the flat solid oxide substrate 1 in such a manner as to face each other with the solid oxide substrate 1 interposed therebetween. A lead wire L1 is connected to the cathode electrode layer 2 and a lead wire L2 to the anode electrode layer 3, and the fuel cell output is taken out through the lead wires L1 and L2. The solid oxide substrate 1 need only be formed in a plate-like shape, and need not be limited to the rectangular shape but can be formed in any suitable shape as long as it is shaped so as to be exposed to the premixed gas combustion flame produced by the burner of the gas-fired stove; for example, the substrate can be formed in a circular shape or in a shape that encircles the burner.

For the solid oxide substrate 1, known materials can be used and, examples include the following:

a) YSZ (yttria-stabilized zirconia), ScSZ (scandia-stabilized zirconia), and zirconia-based ceramics formed by doping these materials with Ce, Al, etc.

b) SDC (samaria-doped ceria), GDC (gadolinium-doped ceria), and other ceria-based ceramics.

c) LSGM (lanthanum gallate) and bismuth oxide-based ceramics.

For the anode electrode layer 3, known materials can be used, examples including the following:

d) Cermet of nickel and a ceramic based on yttria-stabilized zirconia or scandia-stabilized zirconia or a ceramic based on ceria (SDC, GDC, YDC, etc.).

e) Sintered material composed principally of electrically conductive oxide (50% to 99% by weight) (electrically conductive oxide is, for example, nickel oxide containing lithium in solid solution).

f) Material given in d) or e) to which a metal made of a platinum-group metallic element or its oxide is added in an amount of about 1% to 10% by weight. Of these materials, d) and e) are particularly preferable.

The sintered material composed principally of electrically conductive oxide given in e) has excellent oxidation resistance, and therefore, can prevent phenomena resulting from the oxidation of the anode electrode layer, such as delamination of the anode electrode layer from the solid oxide layer and degradation of power generation efficiency or inability to generate power due to the rise in the electrode resistance of the anode electrode layer. For the electrically conductive oxide, nickel oxide containing lithium in solid solution is preferable. It will also be noted that high power generation performance can be obtained by adding a metal made of a platinum-group metallic element or its oxide to the material given in d) or e).

For the cathode electrode layer, known materials, which contain an element such as lanthanum selected from group III of the periodic table and doped with strontium (Sr), can be used, and examples include a manganic acid compound (for example, lanthanum strontium manganite), a gallium acid compound and a cobalt acid compound (for example, lanthanum strontium cobaltite).

The cathode electrode layer 2 and the anode electrode layer 3 are both formed in a porous structure. For these electrode layers, the porosity of the porous structure should be set to 20% or higher, preferably 30 to 70%, and more preferably 40 to 50%. In the solid oxide fuel cell unit used in the present embodiments, the cathode electrode layer 2 and the anode electrode layer 3 are both formed in a porous structure, thereby making it easier to supply the oxygen in the air over the entire surface of the interface between the cathode electrode layer 2 and the solid oxide substrate 1 and also making it easier to supply the fuel over the entire surface of the interface between the anode electrode layer 3 and the solid oxide substrate 1.

The solid oxide substrate 1 also can be formed in a porous structure. If the solid oxide substrate were formed in a closely compacted structure, its thermal shock resistance would drop, and the substrate would easily tend to crack when subjected to rapid temperature changes. Furthermore, as the solid oxide substrate is generally formed thicker than the anode electrode layer and the cathode electrode layer, any crack occurring in the solid oxide substrate would lead to the formation of cracks in the entire structure of the solid oxide fuel cell unit which would eventually disintegrate in pieces.

When the solid oxide substrate is formed in a porous structure, its thermal shock resistance increases, and defects such as cracking do not occur even when the substrate is subjected to rapid temperature changes or to a heat cycle involving rapid changes in temperature during power generation. Further, when the porous structure was fabricated with a porosity of less 10%, no appreciable improvement in thermal shock resistance was observed, but when the porosity was 10% or higher, good thermal shock resistance was observed, and a better result was obtained when the porosity was increased to 20% or higher. This is presumably because, when the solid oxide substrate is formed in a porous structure, thermal expansion due to heating is absorbed by the pores in the porous structure.

The solid oxide fuel cell unit C is fabricated, for example, in the following manner. First, powders of materials for forming the solid oxide substrate are mixed in prescribed proportions, and the mixture is molded into a flat plate shape. After that, the flat plate-like structure is calcined and sintered to produce the solid oxide layer which serves as the substrate. Here, by adjusting the kinds and proportions of the powder materials including a pore-forming agent and the calcination conditions such as calcination temperature, calcination time, preliminary calcination, etc., solid oxide substrates with various porosities can be produced. A paste is applied in the shape of a cathode electrode layer on one surface of the substrate thus obtained as the solid oxide layer, and a paste is applied in the shape of an anode electrode layer on the opposite surface thereof; thereafter, the entire structure is calcined to complete the fabrication of a single solid oxide fuel cell unit.

The durability of the solid oxide fuel cell unit can be further increased. In this durability increasing method, a metal mesh is embedded in or fixed to each of the cathode electrode and anode electrode layers of the fuel cell unit. This metal mesh may also be used as a current collecting electrode of the solid oxide fuel cell unit to increase the current collecting efficiency. In the case of the embedding method, the material (paste) for forming each layer is applied over the solid oxide substrate, and the metal mesh is embedded in the thus applied material, which is then calcined. In the case of the fixing method, the metal mesh is not completely embedded in each layer material but may be fixed on a surface of it, followed by sintering.

For the metal mesh, a material that has excellent heat resistance, and that well matches the thermal expansion coefficient of the cathode electrode layer and anode electrode layer which the metal mesh is to be embedded in or fixed to, is preferred for use. Specific examples include a platinum metal and a platinum-containing metal alloy formed in the shape of a mesh. Alternatively, stainless steel of SUS 300 series (for example, 304, 316, etc.) or SUS 400 series (for example, 430, etc.) may be used; these materials are advantageous in terms of cost.

Instead of using the metal mesh, metal wires may be embedded in or fixed to the anode electrode layer and the cathode electrode layer. The metal wires are formed using the same metal material as that used for the metal mesh, and the number of wires and the configuration of the wire arrangement are not limited to any particular number or configuration. The metal meshes or metal wires embedded in or fixed to the anode electrode layer and the cathode electrode layer serve to reinforce the structure so that the solid oxide substrate, if cracked due to its thermal history, etc., will not disintegrate; furthermore, the metal meshes or the metal wires act to electrically connect cracked portions.

The above description has been given by dealing with the case where the solid oxide substrate is formed in a porous structure, but it will be recognized that when the solid oxide substrate of the fuel cell is formed in a closely compacted structure, the metal meshes or the metal wires embedded in or fixed to the cathode electrode layer and the anode electrode layer provide particularly effective means to cope with the problem of cracking due to thermal history.

Cracks can also occur in the solid oxide fuel cell unit because of rapid heating when the gas-fired stove is turned on; however, when the metal meshes or metal wires are embedded or buried at a suitable density in the cathode electrode layer and the anode electrode layer, the metal meshes or metal wires act to conduct the heat evenly over the surface of the fuel cell unit during rapid heating, thus serving to prevent cracking that could occur due to uneven heat conduction.

The metal mesh or the metal wires may be provided in both the anode electrode layer and the cathode electrode layer or in either one of the layers. Further, the metal mesh and the metal wires may be used in combination. When the metal mesh or the metal wires are embedded at least in the anode electrode layer, then if cracking occurs due to thermal history, the power generation performance of the fuel cell does not degrade and the fuel cell can continue to generate power. As the power generation performance of the solid oxide fuel cell unit is largely dependent on the effective area of the anode electrode layer as the fuel electrode, the metal mesh or the metal wires should be provided at least in the anode electrode layer.

The thus fabricated solid oxide fuel cell unit is used as the fuel cell unit C in the solid-oxide fuel-cell power generating apparatus of the present embodiments. In the present embodiments, the premixed gas combustion flame produced by the burner of the gas-fired stove is directly used as the fuel to be supplied to the anode electrode layer 3 formed on the solid oxide fuel cell unit. The temperature of the heat generated by the premixed gas combustion flame is substantially the same as that of the flame generated in the apparatus of FIG. 5, which means that the solid oxide fuel cell unit can be operated with the premixed gas combustion flame. Accordingly, the gas-fired stove provides combustion suitable not only as the fuel supply source but also as the driving heat source for the solid oxide fuel cell unit.

Next, a description will be given of the gas-fired stove that is used as the fuel supply source for the solid oxide fuel cell unit in the power generating apparatus of the present embodiments.

A traditionally known gas-fired stove used, for example, for cooking may be used as the fuel source in the present embodiments. This kind of gas-fired stove is equipped with a gas burner for burning a fuel gas. A fuel gas is injected at high speed into the gas burner through a small injection port provided in one end of the burner body. Utilizing the pressure drop occurring at this time, air is drawn into the gas burner. The fuel gas and the air are mixed together inside the gas burner body.

The mixture gas thus produced inside the gas burner body is introduced into a plurality of burner ports, i.e., openings for burning, formed in the other end of the burner body. In the case of a gas-fired stove used for cooking, the plurality of burner ports are usually arranged in a circular pattern. Not only the type in which the plurality of burner ports are arranged in a circular pattern, but also the type in which the plurality of burner ports are arranged in straight lines can be employed for the gas-fired stove used as the fuel source for the power generating apparatus of the present embodiments.

When the mixture gas injected through the plurality of burner ports ignites, the fuel burns at each burner port, forming a premixed gas combustion flame. In this premixed gas combustion flame, the flow of the mixture gas injected upward through the burner port and the propagation of the flame produced by the burning of the mixture gas are in equilibrium, forming a flame front, the flame being anchored in the burner port and stable combustion taking place.

Conventional gas-fired stoves are designed to be able to adjust the amount of gas combustion; here, since incomplete combustion may occur if the air/fuel ratio is not properly adjusted, the gas-fired stoves are also equipped with mechanisms for adjusting the amount of air to match the amount of fuel combustion so that a stable premixed gas combustion flame is produced. Accordingly, the premixed gas combustion flame can be stably supplied as the fuel for the solid oxide fuel cell unit used in the power generating apparatus of the present embodiments, and thus the premixed gas combustion flame can advantageously be used to obtain a stable amount of power generation.

City gas, such as liquefied natural gas (LNG), petroleum cracking gas, and liquefied petroleum gas (LPG), is used as the fuel for home gas-fired stoves. The premixed gas combustion flame produced by burning such city gas is suitable as a fuel for the solid oxide fuel cell unit used in the power generating apparatus of the present embodiments because, as described above, the premixed gas combustion flame is rich in radicals and unburned components.

In the gas-fired stove described above, the mixture gas is burned by the burner and a consistent and stable premixed gas combustion flame is formed; as a result, not only can the premixed gas combustion flame be used as the heat source for cooking but, because the premixed gas combustion flame contains radicals produced by the combustion of the fuel, it can also be used as the heat source and fuel source necessary for the power generating operation of the solid oxide fuel cell unit used in the power generating apparatus of the present embodiments, and thus a direct-flame type fuel-cell power generating apparatus can be constructed that directly utilizes the premixed gas combustion flame.

By disposing the flat plate solid oxide fuel cell unit so as to be exposed directly to the premixed gas combustion flame produced by the burner of the gas-fired stove, the direct-flame solid-oxide fuel-cell power generating apparatus is constructed which can continue to generate power stably, and from which the power generation output can be easily extracted. Next, a description will be given of the embodiments of the solid-oxide fuel-cell power generating apparatus that utilizes the premixed gas combustion flame produced by the burner of the gas-fired stove; the following description is given with reference to two embodiments, the first embodiment in which the power generating apparatus is constructed to be able to generate power while the gas-fired stove is being used for cooking, and the second embodiment in which the apparatus is constructed to be able to generate power while the gas-fired stove is being used for other purposes, for example, for space-heating purposes.

### First Embodiment

FIG. 1 shows the first embodiment of the direct-flame solid-oxide fuel-cell power generating apparatus which uses the premixed gas combustion flame produced by the burner of the gas-fired stove not only as a source that can supply fuel to the solid oxide fuel cell unit but also as a heat source for maintaining the fuel cell unit at its operating temperature. The power generating apparatus of FIG. 1 uses a conventional gas-fired stove. Shown in FIG. 1 is a side view of the right-hand half of the gas-fired stove.

The gas-fired stove comprises a stove body 5, a burner 6, and trivet legs 7, the burner 6 being located in the center of the stove body 5. The trivet legs 7 are arranged at equally spaced intervals in such a manner as to encircle the burner 6. A plurality of burner ports are formed along the upper periphery of the burner 6; when the mixture gas generated inside the burner body mounted in the stove body is injected through the burner ports and ignites, the premixed gas combustion flame F is formed, as previously described. FIG. 1 shows that cooking is being done with a cooking vessel 8 placed on the trivet legs 7.

In FIG. 1, to construct the solid-oxide fuel-cell power generating apparatus that utilizes the gas-fired stove, the solid oxide fuel cell unit C, whose structure is substantially the same as that of the solid oxide fuel cell unit shown in FIG. 5, is supported at a position near and opposite the burner 6. The solid oxide fuel cell unit C thus positioned is directly exposed to the premixed gas combustion flame produced by the burner 6.

Here, the solid oxide fuel cell unit C is supported in position by using the lead wires L1 and L2 attached to the fuel cell unit, and the lead wires L1 and L2 are chosen to have a diameter that can provide enough strength to support the fuel cell unit C in position. The supporting height of the fuel cell unit C is chosen so as not to exceed the height of the trivet legs 7 so that the upper end of the fuel cell unit does not contact or hit the bottom the cooking vessel 8. By thus limiting the height, even when cooking is being done on the gas-fired stove, the fuel cell unit C can be operated to generate power stably without interfering with the operation of the gas-fired stove.

Further, to hold the thus supported solid oxide fuel cell C fixed in position with respect to the burner 6, a fuel cell mounting base 9 is installed on the upper surface of the stove body 5. The fuel cell mounting base 9 is formed from an electrically insulating and heat resistant material, and holds the lead wires L1 and L2, for example, by embedding them therein. The solid oxide fuel cell C is supported on the fuel cell mounting base 9 with the anode electrode layer 3 facing the burner 6.

The lead wires L1 to L2 are connected to a load placed some distance away from the stove body 5. It is convenient if the fuel cell mounting base 9 is detachably mounted on the stove body 5, because it can be removed when power generation is not necessary or when cleaning the stove. Furthermore, with the detachable base, the power generating apparatus can be easily mounted even on a commercially available standard gas-fired stove.

According to the solid-oxide fuel-cell power generating apparatus constructed as described above, the heat produced during the heating and cooking operation of the gas-fired stove serves to hold the solid oxide fuel cell unit C at its operating temperature, and the premixed gas combustion flames formed from the burner ports, and hence the radicals or unburned components contained in the flames, are directly fed to the anode electrode layer 3.

On the other hand, the cathode electrode layer 2 of the solid oxide fuel cell unit C is located on the side opposite from the burner 6, and is therefore supplied with a sufficient amount of oxygen. Here, since the solid oxide fuel cell unit C is formed in a flat plate shape, the fuel-rich condition in the anode electrode layer and the oxygen-rich condition in the cathode electrode layer can be easily created. The lead wire L1 is connected to the cathode electrode layer 2, and the lead wire L2 to the anode electrode layer 3; with these lead wires L1 and L2, the generated power is extracted outside the fuel cell. As the lead wires L1 and L2 made of metal can be easily bent, the tilt angle of the solid oxide fuel cell unit C can be readily adjusted to achieve an optimum fuel-rich condition in the anode electrode layer.

In the example of the solid-oxide fuel-cell power generating apparatus described above, the plurality of burner ports of the burner 6 used as the heat source and fuel source for the solid oxide fuel cell unit C has been described as being arranged in a circular pattern, but the arrangement of the burner ports is not limited to the circular arrangement; for example, even when the burner ports are arranged in straight lines, the solid oxide fuel cell unit C can be mounted on the fuel cell mounting base 9 and used in the same manner as when the burner ports are arranged in a circular pattern.

The solid-oxide fuel-cell power generating apparatus according to the first embodiment described above comprises only one solid oxide fuel cell unit C. Next, referring to FIG. 2, a modified example of the first embodiment will be described which uses a plurality of solid oxide fuel cell units.

In FIG. 2, the construction of the gas-fired stove is not shown, but the construction of only the power generating apparatus is shown. While the power generating apparatus shown in FIG. 1 comprises one solid oxide fuel cell unit C, the power generating apparatus shown in FIG. 2 comprises, for example, three solid oxide fuel cell units C1 to C3. Here, the fuel cell mounting base 9 is formed in an annular shape encircling the burner 6 of the gas-fired stove, and the diameter of the mounting base 9 is chosen so that a suitable gap is provided between the mounting base 9 and the burner 6. In FIG. 2, three solid oxide fuel cell units are shown, but a larger number of solid oxide fuel cell units may be arranged around the burner 6.

The fuel cell mounting base 9 may be fixed to the stove body but, as the trivet 7 of the gas-fired stove is usually mounted detachably, the fuel cell mounting base 9 may also be detachably mounted on the stove body. In this modified example also, the fuel cell mounting base 9 is formed from an electrically insulating and heat resistant material. In FIG. 2, lead wires L11 to L32 from the solid oxide fuel cell units C1 to C3 are individually attached to the fuel cell mounting base 9.

In the example of FIG. 2, the lead wires L12 and L21 and the lead wires L22 and L31, respectively, are electrically connected together by detachable conductors W1 and W2, for example, metal clips or the like, thus connecting the solid oxide fuel cell units C1 to C3 in series to obtain a high electromotive voltage. Alternatively, though not shown here, the lead wires L11, L21, and L31 and the lead wires L12, L22, and L32, respectively, may be connected together to connect the fuel cell units in parallel so that a larger amount of output current can be extracted. It is also possible to connect the fuel cell units in series and parallel.

In the power generating apparatus of FIG. 2, each lead wire is attached in such a manner as to protrude from the fuel cell mounting base 9, but instead, the lead wire portion that is connected to another lead wire may be embedded in the fuel cell mounting base 9, allowing only the lead wire portion from which the power of the power generating apparatus is output to protrude outside. By eliminating unnecessary protrusions in this way, the apparatus can be made easier to handle.

In the solid-oxide fuel-cell power generating apparatus according to the modified example described above, the cathode electrode layer 2 of each of the solid oxide fuel cell units C1 to C3 is located on the opposite side from the burner 6, and is therefore supplied with a sufficient amount of oxygen. Here, as each of the solid oxide fuel cell units C1 to C3 is formed in a flat plate shape, the fuel-rich condition in the anode electrode layer and the oxygen-rich condition in the cathode electrode layer can be easily created, and power can be generated stably and easily.

### Second Embodiment

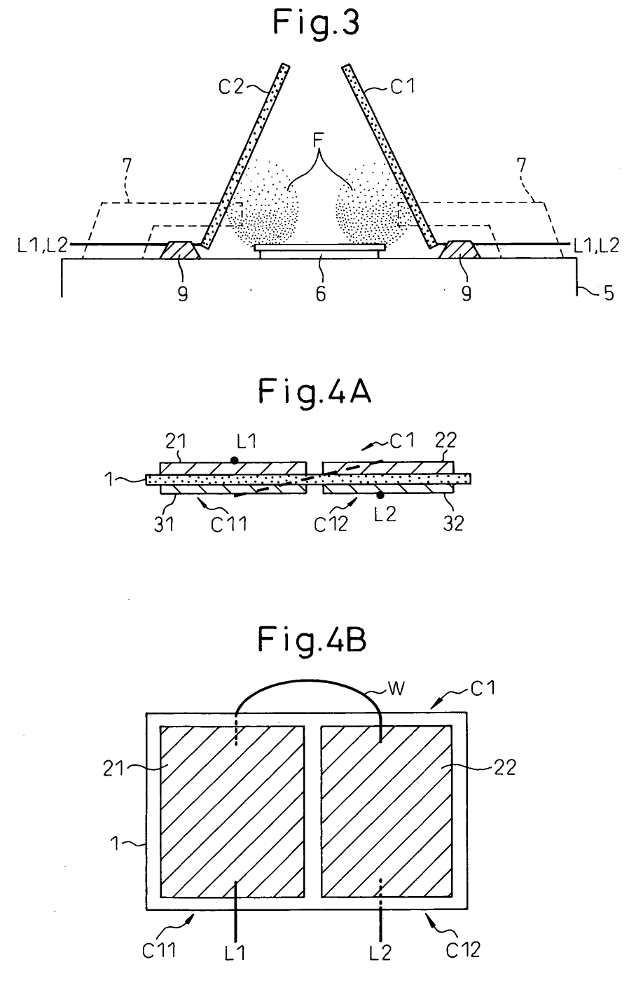

In the first embodiment described above, the power generating apparatus has been constructed to be able to generate power while the gas-fired stove is being used for cooking; on the other hand, in the second embodiment described hereinafter with reference to FIG. 3, the power generating apparatus is constructed so that power can be generated while using the gas-fired stove for other purposes, for example, simply as a fuel source for the power generating apparatus, or as a space-heating apparatus.

As in the power generating apparatus of the first embodiment, the solid-oxide fuel-cell power generating apparatus shown in FIG. 3 uses a gas-fired stove similar to that shown in FIG. 1, and uses the premixed gas combustion flames produced by the burner as the fuel for the solid oxide fuel cell units. In FIG. 3, the same parts as those in FIG. 1 are designated by the same reference characters. The gas-fired stove used here also comprises the stove body 5, burner 6, and trivet legs 7.

However, the power generating apparatus of the second embodiment differs from the power generating apparatus of the first embodiment in the size of the solid oxide fuel cell unit used in the power generating apparatus. In the first embodiment, the height of the solid oxide fuel cell unit has been limited because of the need to generate power without compromising the heating and cooking performance of the gas-fired stove as a cookstove, but in the second embodiment, as there is no need to generate power during cooking, the size of the solid oxide fuel cell unit is increased exceeding the height of the trivet 7 so that the premixed gas combustion flame from the burner 6 can be effectively utilized.

As shown in FIG. 3, the solid oxide fuel cell units C1 and C2 are each supported by the lead wires L1 and L2 attached to the fuel cell mounting base 9, and are disposed with their anode electrode layers facing the burner 6. When the solid oxide fuel cell units C1 and C2 are directly exposed to the premixed gas combustion flames produced by the burner 6, the solid oxide fuel cell units are heated and glow, each solid oxide fuel cell unit thus acting as an infrared radiator. The infrared rays being radiated from the solid oxide fuel cell units can be used for space heating. In the second embodiment, as the power generation effective area of each solid oxide fuel cell unit is made larger than that in the first embodiment, the gas-fired stove can be used simply as a fuel source for the power generating apparatus. The apparatus can therefore be used advantageously, for example, as a standby power supply in an emergency situation or in outdoor applications.

The size of each solid oxide fuel cell unit should be chosen so that the entire surface of the anode electrode layer is exposed to the premixed gas combustion flame produced by the burner 6, and each solid oxide fuel cell unit should be tilted toward the burner 6. FIG. 3 has shown the case in which two solid oxide fuel cell units C1 to C3 are used, but it is also possible to use a larger number of solid oxide fuel cell units. In that case, an annular fuel cell mounting base such as shown in FIG. 2 can be used as the fuel cell mounting base 9.

In the solid-oxide fuel-cell power generating apparatus according to the second embodiment described above, the cathode electrode layer 2 of each of the solid oxide fuel cell units C1 and C2 is located on the opposite side from the burner 6, and is therefore supplied with a sufficient amount of oxygen. Here, since each of the solid oxide fuel cell units C1 and C2 is formed in a flat plate shape, the fuel-rich condition in the anode electrode layer and the oxygen-rich condition in the cathode electrode layer can be easily created, and power can be generated stably and easily.

Further, in the power generating apparatus of the second embodiment, the trivet 7 need not necessarily be mounted on the stove body because the gas-fired stove is not used for cooking. Therefore, the solid oxide fuel cell unit may be formed in a truncated cone shape with the anode electrode layer on the inside and the cathode electrode layer on the outside, and this solid oxide fuel cell unit may be mounted on the stove body 5 with the burner 6 in its center after removing the trivet 7.

The solid oxide fuel cell units C1 and C2 used in the power generating apparatus of the second embodiment shown in FIG. 3 have each been fabricated by forming the cathode electrode layer and the anode electrode layer on a single solid oxide substrate, but instead, a plurality of solid oxide fuel cell units may be formed on a single solid oxide substrate as shown in FIGS. 4A and 4B; in that case, by ingeniously connecting the respective solid oxide fuel cell units, the electromotive voltage can be increased or the magnitude of the output current can be adjusted, despite the single solid oxide fuel cell unit structure.

FIGS. 4A and 4B show the structure of the solid oxide fuel cell unit according to a modified example of the second embodiment by taking as an example the solid oxide fuel cell unit C1 shown in FIG. 3. FIG. 4A shows a side view of the solid oxide fuel cell, and FIG. 4B shows a plan view of the same. The solid oxide fuel cell of the modified example shown in FIGS. 4A and 4B can be applied to a direct-flame type apparatus such as shown in FIG. 5.

As shown in FIGS. 4A and 4B, the solid oxide fuel cell according to the modified example of the present embodiment comprises a flat plate solid oxide electrolyte substrate 1, a plurality of cathode electrode layers, i.e., two cathode electrode layers 21 and 22 in the example of FIGS. 4A and 4B, formed on one surface of the substrate, and two anode electrode layers 31 and 32 formed on the opposite surface thereof, wherein the cathode electrode layer 21 and the anode electrode layer 31 together constitute a fuel cell unit C11, and the cathode electrode layer 22 and the anode electrode layer 32 together constitute a fuel cell unit C12.

Here, an electromotive force extracting lead wire L1 is attached to the cathode electrode layer 21, and likewise, an electromotive force extracting lead wire L2 is attached to the anode electrode layer 32. The cathode electrode layer 22 and the anode electrode layer 31 are electrically connected by a connecting wire W. The lead wires and the connecting wire are formed from a heat-resistant platinum material or a platinum-containing alloy.

Premixed gas combustion flames produced by the burner 6 are supplied as fuel to the entire surfaces of the anode electrode layers 31 and 32 of the solid oxide fuel cell units C11 and C12. In the example of FIGS. 4A and 4B, as the fuel cell units C11 and C12 are connected in series, an output equal to the sum of the electromotive forces produced by the respective fuel cell units C11 and C12 is obtained between the lead wires L1 and L2.

In the first and second embodiments described above, the lead wires from the solid oxide fuel cell units are fixedly attached to the fuel cell mounting base, thereby supporting the solid oxide fuel cell units in position. The present invention is not limited to this construction, but the lead wires from the solid oxide fuel cell units may be attached to the fuel cell mounting base in detachable fashion by using metal braces or the like. When the lead wires are detachable from the mounting base, work such as replacing a failed fuel cell unit, changing the size of the fuel cell unit, or adjusting the number of fuel cell units used, can be easily done.

### EXAMPLE

An example will be described for the solid-oxide fuel-cell power generating apparatus of the first embodiment. A solid oxide fuel cell unit was fabricated in accordance with the power generating apparatus shown in FIG. 2, and a power generation experiment was conducted using a gas-fired stove.

First, a solid electrolyte formed from samaria-doped ceria (SDC, Sm_{0.2}Ce_{0.8}O_{1.9} ceramic) was used as the solid oxide substrate. Using a green sheet process, the solid electrolyte was calcined at 1300° C. in the atmosphere to produce a ceramic substrate with a thickness of 200 μm and a diameter of 15 mm. Next, a paste prepared by mixing samaria strontium cobaltite (SSC, Sm_{0.2}Sr_{0.5}Ce_{0.8}O₃) and SDC in proportions of 50% by weight to 50% by weight was applied on one surface of the substrate to print a pattern with a diameter of 13 mm, and the paste was dried.

Further, a paste prepared by mixing nickel oxide containing 8% by mole of lithium in solid solution and SDC in proportions of 60% by weight to 40% by weight, with 5% by weight of rhodium oxide added thereto, was applied on the opposite surface of the substrate to print a pattern with a diameter of 13 mm, and a platinum mesh to which a platinum wire as a lead wire was welded was embedded in each surface. Thereafter, the entire structure was calcined at 1200° C. in the atmosphere to produce a single solid oxide fuel cell unit.

Three solid oxide fuel cell units were fabricated in the above manner, and the lead wires of the three fuel cell units were attached to a fuel cell mounting base made of a porous alumina-based ceramic by using an alumina-silica-based inorganic adhesive. Then, the lead wires protruding on the side opposite from the solid oxide fuel cell units were connected together by electrically conductive clips to connect the respective fuel cell units in series, thus completing the fabrication of the power generating apparatus.

Then, the fuel cell mounting base was placed so that the solid oxide fuel cell units constituting the power generating apparatus were disposed at positions inward of the trivet and near and opposite the burner in such a manner as to encircle the burner of the gas-fired stove loaded with a fuel gas cartridge. After that, the mixture gas injected through the burner was ignited, and the solid oxide fuel cell units were exposed to the premixed gas combustion flames produced.

When the angle of each solid oxide fuel cell unit, relative to the premixed gas combustion flame, was suitably adjusted so as to achieve an optimum exposure condition, an open circuit voltage of about 1.8 to 2.1 V was confirmed. Next, a kettle containing water was placed on the trivet, and the gas was ignited; then, when the angle of each solid oxide fuel cell unit relative to the premixed gas combustion flame was again adjusted, it was confirmed that an open circuit voltage of about 1.8 V was obtained. When a portable FM/AM radio was connected to the ends of the lead wires, it was confirmed that a broadcast program could be heard, and, therefore, that the power generating apparatus was operating continuously.

What is claimed is:

1. A solid-oxide fuel-cell power generating apparatus comprising:
a solid oxide fuel cell unit having a solid oxide substrate, a cathode electrode layer formed on one surface of said substrate, and an anode electrode layer formed on a surface of said substrate opposite from said one surface; and
a fuel cell mounting base which supports said solid oxide fuel cell unit in such a manner that said anode electrode layer is directly exposed to a premixed gas combustion flame produced by a burner of a gas-fired heater, wherein
power is generated by supplying components of said premixed gas combustion flame to said anode electrode layer and air to said cathode electrode layer.

2. A solid-oxide fuel-cell power generating apparatus as claimed in claim 1, wherein a current collecting electrode provided in either one or both of said cathode electrode layer and said anode electrode layer is formed from a metal mesh spreading over an entire surface of said electrode layer.

3. A solid-oxide fuel-cell power generating apparatus as claimed in claim 1, wherein said fuel cell mounting base is provided on a top surface of a body of said gas-fired heater, and said solid oxide fuel cell unit is disposed so as to face said burner.

4. A solid-oxide fuel-cell power generating apparatus as claimed in claim 1, wherein said fuel cell mounting base is capable of supporting said solid oxide fuel cell unit in such a manner as to be freely tilted at a desirable angle.

5. A solid-oxide fuel-cell power generating apparatus as claimed in claim 1, wherein said solid oxide fuel cell unit is supported on said fuel cell mounting base by means of a power extracting lead wire attached to said fuel cell unit.

6. A solid-oxide fuel-cell power generating apparatus as claimed in claim 1, wherein a plurality of said solid oxide fuel cell units are arranged so as to face said burner.

7. A solid-oxide fuel-cell power generating apparatus as claimed in claim 6, wherein said plurality of solid oxide fuel cell units are connected in series or parallel or in series and parallel.

8. A solid-oxide fuel-cell power generating apparatus as claimed in claim 7, wherein said series or parallel connection or said series and parallel connection of said plurality of solid oxide fuel cell units is accomplished by means of an electrical conductor detachable from lead wires attached to said solid oxide fuel cell units.

9. A solid-oxide fuel-cell power generating apparatus as claimed in claim 1, wherein an upper end of said solid oxide fuel cell unit does not protrude above an upper surface of a trivet placed on said gas-fired heater.

10. A solid-oxide fuel-cell power generating apparatus as claimed in claim 1, wherein an upper end of said solid oxide fuel cell unit protrudes above an upper surface of a trivet placed on said gas-fired heater.

11. A solid-oxide fuel-cell power generating apparatus as claimed in claim 1, wherein said solid oxide fuel cell unit comprises a plurality of cathode electrode layers formed on one surface of said solid oxide substrate and a plurality of anode electrode layers formed on a surface of said solid oxide substrate opposite from said one surface, and a plurality of fuel cell units are formed by said anode electrode layers and said cathode electrode layers formed opposite each other across said solid oxide substrate.

12. A solid-oxide fuel-cell power generating apparatus as claimed in claim 1, wherein said solid oxide fuel cell unit is supported on said fuel cell mounting base in a freely detachable manner.
